(19) United States
(12) Patent Application Publication
(10) Pub. No.: US 2021/0018208 A1
(43) Pub. Date: Jan. 21, 2021

(54) AIR CONDITIONER AND AUGMENTED REALITY APPARATUS FOR INFORMING INDOOR AIR CONDITION, AND CONTROLLING METHOD THEREFOR

(71) Applicant: LG ELECTRONICS INC., Seoul (KR)

(72) Inventors: Won Ho SHIN, Seoul (KR); Ji Chan MAENG, Seoul (KR)

(73) Assignee: LG ELECTRONICS INC., Seoul (KR)

(21) Appl. No.: 16/685,701

(22) Filed: Nov. 15, 2019

(30) Foreign Application Priority Data
Jul. 16, 2019 (KR) 10-2019-0085724

(51) Int. Cl. F24F 11/64; G02B 27/01; G06F 3/01; G06T 7/73; F24F 11/88; F24F 11/52; F24F 11/58; F24F 11/79

(52) U.S. Cl. CPC F24F 11/64; G02B 27/0172; G06F 3/011; G06T 7/75; F24F 11/88; F24F 11/52; G06T 2207/20084; F24F 11/79; G02B 2027/0141; G02B 2027/0138; G02B 2027/014; G02B 2027/0178; G06T 2207/20081; F24F 11/58

(57) ABSTRACT

The present disclosure relates to an air conditioner and an augmented reality apparatus for informing an indoor air condition and a control method therefor. The air conditioner informing an indoor air condition may include a sensor configured to sense an air condition, one or more processors controller configured to control an air discharging operation of the air conditioner, estimate an air condition of a space within a predetermined range from the air conditioner based on information on an air discharging operation of the air conditioner and information on the air condition sensed by the sensor. Here, the processor may estimate a space-specific air condition of an indoor space using a depth neural network model that is pretrained and estimate the air condition in consideration of the operation of other air conditioners in the Internet of things environment through the 5G communication environment.

### CROSS-REFERENCE TO RELATED APPLICATION

Pursuant to 35 U.S.C. § 119(a), this application claims the benefit of earlier filing date and right of priority to Korean Patent Application No. 10-2019-0085724, filed on Jul. 16, 2019, the contents of which are all hereby incorporated by reference herein in its entirety.

### BACKGROUND

### 1. Technical Field

The present disclosure relates to an air conditioner and an augmented reality apparatus for informing an indoor air condition and a control method therefor. More particularly, the present disclosure relates to an air conditioner and an augmented reality apparatus for informing a space-specific air condition on the basis of an air condition detected by an air conditioner and external sensors and an operation of an air conditioner, and a control method therefor.

### 2. Description of Related Art

As climate change and air pollution worsen, an air conditioner for controlling an indoor air condition has become an essential appliance in home and office.

An air conditioner is disposed in an area of a room and performs functions of controlling the temperature, humidity, and air pollution level, for example, fine dust and ultrafine dust concentration, of an indoor space. A user inputs information on the target air condition into the air conditioner or sets the operation intensity level of the air conditioner, and the air conditioner performs the operation according thereto.

As the operation of the air conditioner directly affects the living environment of the user, in order to improve the user experience of using the air conditioner, technology for the user to better interact with the air conditioner have been researched.

Korean Patent No. 1774310, entitled “Air Conditioner,” discloses a technology that allows an air conditioner unit selected through a mobile terminal to check the electrical power usage rates and the operating status of the air conditioning unit in real time.

According to the above-mentioned document, the electrical power usage rates according to the operating status and power consumption of the air conditioning unit selected by the user may be known, but the air conditioning unit of the related art does not provide information on the living environment of a user.

U.S. Pat. No. 10,146,194, entitled “Building Lighting and Temperature Control with an Augmented Reality System,” discloses a technology for detecting environmental conditions related to lighting and temperature in a building via sensors, expressing it through augmented reality, and providing it to a user.

According to the description of the above-mentioned document, the environmental conditions sensed by the sensors may be transmitted to the user, but there is a shortcoming in that information on the environmental condition of an area not detected by sensors may not be provided to the user.

In order to effectively better understand the effect of air conditioner operations on the air condition of a user's living space, there is a need for technology related to air conditioners that may provide more detailed information on the air condition of the living spaces of users.

The above-described related art is technical information that the inventor holds for deriving the present disclosure or is acquired in the derivation process of the present disclosure, and is not necessarily a known technology disclosed to the general public before the application of the present disclosure.

### SUMMARY OF THE INVENTION

An aspect of the present disclosure is to address the shortcoming of an air conditioner not capable of checking the effect the air conditioner has on the actual air condition of a user's living space when the air conditioner is being used.

In addition, an aspect of the present disclosure is to address the shortcoming of the user setting an operation target for the air conditioner, and the air conditioner not capable of checking whether the set operation target in the indoor atmospheric environment is being achieved.

In addition, an aspect of the present disclosure is to address the shortcoming of the user not being able to check the air condition of an area located at a distance from an air conditioner and the air condition of an adjacent area where the air conditioner is disposed.

In addition, an aspect of the present disclosure is to address the shortcoming of a difficulty for the user to obtain an intuitive understanding of the actual atmospheric environment simply by reading information on an air condition sensed by sensors and displayed on an air conditioner.

The air conditioner according to an embodiment of the present disclosure is installed in a room to detect an air condition, perform an air discharging operation, and estimate an air condition around the air conditioner based on the performed air discharging operation and the sensed air condition information.

Here, the air conditioner may transmit the estimated air condition to a user terminal, and the user may check the indoor air condition changed by the operation of the air conditioner through the user terminal.

The air conditioner according to another embodiment of the present disclosure divides at least a part of the indoor space into a plurality of spaces and estimates an air condition of each space based on the air condition sensed by the sensor and the air discharging operation of the air conditioner.

Here, the air conditioner may transmit the estimated air condition to an augmented reality apparatus, and the user may check the air condition of the indoor space through the augmented reality apparatus.

The air condition of the indoor space that may be visually checked by the user may include the direction of the wind, the speed of the wind, and air cleanliness of each space.

The augmented reality apparatus according to an embodiment of the present disclosure may communicate with an air conditioner installed in the room to receive information on an operation of the air conditioner and the air condition, and estimate the indoor air condition based on the received air condition information and information on the operation of the air conditioner.

Here, the augmented reality apparatus adds the estimated air condition to an actual space shown by the augmented reality apparatus, allowing the user to visually check the air condition of the space in addition to the actual space.

An air conditioner informing an indoor air condition according to an embodiment of the present disclosure may include a sensor configured to sense an air condition, a controller configured to control an air discharging operation of the air conditioner, an estimator configured to estimate an air condition of a space within a predetermined range from the air conditioner based on information on the air discharging operation of the air conditioner determined by the controller and information on the air condition sensed by the sensor, and a transmitter configured to transmit information on the estimated air condition of the space to a user terminal. In some implementations, the controller and the estimator may correspond to one or more processors. In other implementations, the controller and the estimator may correspond to software components configured to be executed by one or more processors.

Here, the information on the air discharging operation of the air conditioner may include at least one of a wind direction or a wind speed of air discharged by the air conditioner.

The estimator of the air conditioner according to another embodiment of the present disclosure may divide at least a part of an indoor space into a plurality of spaces, and estimate an air condition of each of the plurality of spaces.

Here, the information on the air condition of the space may include a first air condition information on a first space and a second air condition information on a second space, and the second space may be a space set more remotely from the air conditioner than the first space.

In addition, the first space may be a space set at a distance closest to the air conditioner, the first air condition of the first space may be determined based on the air condition information sensed by the sensor, and the second air condition may be determined based on the first air condition, a positional relationship between the first space and the second space, and information on the air discharging operation of the air conditioner.

The air conditioner according to another embodiment of the present disclosure may further include a receiver configured to receive additional air condition information sensed by at least one external sensor.

In addition, the estimator may estimate the air condition of the space within the predetermined range from the air conditioner based on information on the air discharging operation of the air conditioner, information on the air condition sensed by the sensor, and additional air condition information received via the receiver.

An augmented reality apparatus informing an indoor air condition according to an embodiment of the present disclosure may include a camera configured to capture an indoor space, a receiver configured to receive, from an air conditioner, information on an operation of the air conditioner and information on an air condition sensed by a sensor of the air conditioner, an estimator configured to estimate the air condition of the indoor space based on the information on the operation of the air conditioner and the information on the air condition sensed by the sensor of the air conditioner, and an augmented reality generator configured to synthesize information on the air condition of the indoor space estimated by the estimator with the indoor space image captured by the camera and display the synthesized result on a display. In some implementations, the augmented reality generator may correspond to one or more processors. In other implementations, the augmented reality generator may correspond to software components configured to be executed by one or more processors.

Here, the information on the operation of the air conditioner may include information on a blowing intensity and a blowing direction of the air conditioner, and the air condition may include at least one of temperature, humidity, or air pollution level.

In an augmented reality apparatus according to another embodiment of the present disclosure, the camera may capture an air conditioner disposed in the indoor space.

Here, the estimator of the augmented reality apparatus may estimate a position of the air conditioner in the indoor space based on an image of the air conditioner placed in the indoor space captured by the camera, and estimate a space-specific air condition of the indoor space based on information on the operation of the air conditioner, information on the air condition sensed by the sensor of the air conditioner, and the estimated location of the air conditioner.

In addition, the estimator may be configured to estimate the space-specific air condition of the indoor space by using a depth neural network model that is pretrained with information on a changed air condition according to the operation of the air conditioner, which is obtained for each space divided according to a distance from the air conditioner.

Here, the space-specific air condition may include a first air condition of a first space and a second air condition of a second space.

In addition, the first space may be a space set at a distance closest to the air conditioner, and the first air condition of the first space may be determined based on information on the air condition sensed by the sensor of the air conditioner.

Furthermore, the second air condition may be determined based on the first air condition, a positional relationship between the first space and the second space, and information on the operation of the air conditioner.

The receiver of the augmented reality apparatus according to another embodiment of the present disclosure may receive additional air condition information sensed from at least one external sensor.

In addition, the estimator may estimate the space-specific air condition of the indoor space based on information on the operation of the air conditioner, information on the air condition sensed by the sensor of the air conditioner, and additional air condition information.

In addition, the space-specific air condition may include a third air condition of a third space and a fourth air condition of a fourth space.

Here, the third space may be a space set at a distance closest to the external sensor, and the third air condition of the third space may be determined based on information on the additional air condition sensed by the external sensor.

Furthermore, the fourth air condition may be determined based on the third air condition and a positional relationship between the third space and the fourth space.

A control method of an air conditioner informing an indoor air condition according to an embodiment of the present disclosure may include sensing an air condition through a sensor, collecting information on an operation of the air conditioner, estimating an air condition of a space within a predetermined range from the air conditioner based on information on the operation of the air conditioner and information on the air condition sensed through the sensor, and transmitting information on the estimated air condition of the space to a user terminal.

Here, the information on the air condition of the space may include a first air condition information on a first space and a second air condition information on a second space, and the second space may be a space set more remotely from the air conditioner than the first space.

In addition, the first space may be a space set at a distance closest to the air conditioner, and the first air condition of the first space may be determined based on the indoor air condition information sensed by the sensor.

Furthermore, the second air condition may be determined based on the first air condition, a positional relationship between the first space and the second space, and information on the operation of the air conditioner.

The control method of the air conditioner informing the indoor air condition according to another embodiment of the present disclosure may further include receiving additional air condition information from at least one external sensor.

Here, the estimating of the air condition may include estimating the air condition of the space within the predetermined range from the air conditioner based on the information on the operation of the air conditioner, the information on the air condition sensed by the sensor, and the additional air condition information.

A control method of an augmented reality apparatus informing an indoor air condition according to an embodiment of the present disclosure may include capturing an indoor space through a camera of the augmented reality apparatus, receiving, from an air conditioner, information on an operation of the air conditioner and information on an air condition sensed by a sensor of the air conditioner, estimating the air condition of the indoor space based on the information on the operation of the air conditioner and the information on the air condition sensed by the sensor of the air conditioner, and synthesizing the information on the estimated air condition of the indoor space with the indoor space image captured by the camera and displaying the synthesized result on a display.

Here, the information on the operation of the air conditioner may include information on a blowing intensity and a blowing direction of the air conditioner, and the air condition may include at least one of temperature, humidity, or air pollution level.

The control method of the augmented reality apparatus according to another embodiment of the present disclosure may include capturing an air conditioner disposed in the indoor space.

Here, the estimating of the air condition may include estimating a position of the air conditioner in the indoor space based on an image of an air conditioner disposed in the indoor space captured by the camera, and estimating the air condition of the indoor space based on the information on the operation of the air conditioner, the information on the air condition sensed by the sensor of the air conditioner, and the estimated position of the air conditioner.

In addition, the estimating of the air condition may include dividing at least a part of the indoor space into a plurality of spaces and estimating an air condition of each of the plurality of spaces.

In addition, the air condition of the indoor space may include a first air condition of a first space and a second air condition of a second space.

Here, the first space may be a space set at a distance closest to the air conditioner, and the first air condition of the first space may be determined based on information on the air condition sensed by the sensor of the air conditioner.

Furthermore, the second air condition may be determined based on the first air condition, a positional relationship between the first space and the second space, and information on the operation of the air conditioner.

In addition, the receiving of the information may include receiving additional air condition information sensed from at least one external sensor, and the estimating of the air condition may include estimating a space-specific air condition of the indoor space based on the information on the operation of the air conditioner, the information on the air condition sensed by the sensor of the air conditioner, and the additional air condition information.

In addition, the space-specific air condition may include a third air condition of a third space and a fourth air condition of a fourth space.

Here, the third space may be a space set at a distance closest to the external sensor, and the third air condition of the third space may be determined based on information on the additional air condition sensed by the external sensor.

Furthermore, the fourth air condition may be determined based on the third air condition and a positional relationship between the third space and the fourth space.

Other aspects and features other than those described above will become apparent from the following drawings, claims, and detailed description of the present disclosure.

### BRIEF DESCRIPTION OF THE DRAWINGS

FIG. 1 is a view for explaining an environment in which an air conditioner operates according to an embodiment of the present disclosure.

FIG. 2 shows a block diagram of an air conditioner according to an embodiment of the present disclosure.

FIG. 3 shows a block diagram of a user terminal according to an embodiment of the present disclosure.

FIG. 4 is a view for explaining information that an air conditioner may provide to a user according to an embodiment of the present disclosure.

FIG. 5 is a view for explaining information that an air conditioner may provide to a user according to another embodiment of the present disclosure.

FIG. 6 is a view for explaining information that an air conditioner may provide to a user according to another embodiment of the present disclosure.

FIG. 7 is a flowchart illustrating an operation of a user terminal according to an embodiment of the present disclosure.

FIG. 8 is a view for explaining a method in which air conditioners operate in conjunction with external servers according to an embodiment of the present disclosure.

FIG. 9 is a view for explaining a method of an air conditioner and a user terminal determining a cleanliness level according to an embodiment of the present disclosure.

### DETAILED DESCRIPTION

Advantages and features of the present disclosure and methods of achieving the advantages and features will be more apparent with reference to the following detailed description of example embodiments in connection with the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, the terms such as “first,” “second,” and other numerical terms may be used herein only to describe various elements, but these elements should not be limited by these terms. Furthermore, these terms such as “first,” “second,” and other numerical terms, are used only to distinguish one element from another element.

Hereinbelow, the example embodiments of the present disclosure will be described in greater detail with reference to the accompanying drawings, and on all these accompanying drawings, the identical or analogous elements are designated by the same reference numeral, and repeated description of the common elements will be omitted.

Meanwhile, according to an embodiment of the present disclosure, an air conditioner may be an air purifier, a humidifier, a blower, or other devices capable of adjusting an air environment. Here, an air purifier will be used as an example for description purposes for convenience of explanation.

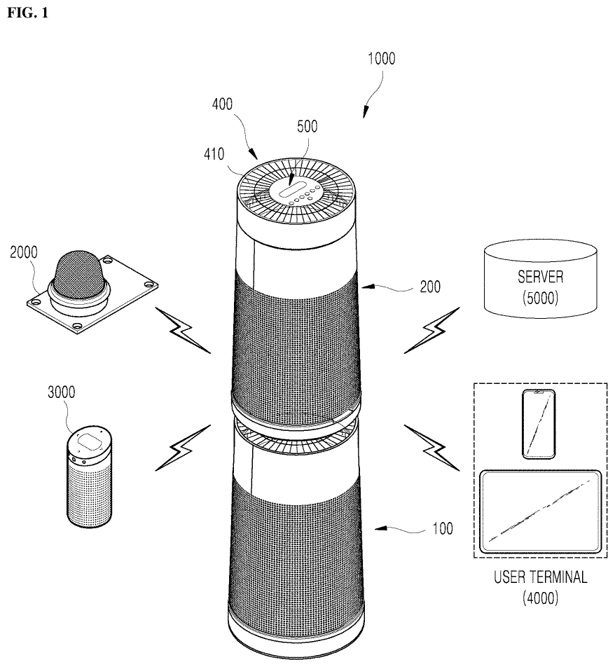

FIG. 1 is a view for explaining an environment in which an air conditioner operates according to an embodiment of the present disclosure.

An air purifier 1000 according to an embodiment of the present disclosure may be disposed in a room and communicate with an artificial intelligent speaker 3000, a user terminal 4000, an external server 5000, and an external sensor 2000 capable of sensing an air condition.

The air purifier 1000 according to an embodiment of the present disclosure may include a first fan device 100, a second fan device 200, and a fan direction adjusting device 400. The fan direction adjusting device 400 may include a ventilation hole 410 and an interface 500 for user interaction.

The air purifier 1000 is disposed in a specific position in the room, and suctions ambient air, filters the air through a filter, and discharges the purified air externally. For this purpose, a fan for air suctioning is installed in each of the first fan device 100 and the second fan device 200, and the outside air may be suctioned into the devices by the operation of the fans.

The air that is suctioned and passed through the filter may become air purified to match an air condition level targeted by the air purifier 1000 and may be emitted externally by the fan direction adjusting device 400.

The air condition of a space where the air purifier 1000 is installed may be changed by the purified air that is emitted externally by the air purifier 1000. The air condition in an indoor area around the air purifier 1000 may have reduced dust levels and improved cleanliness. When a predetermined time passes after the air purifier 1000 begins to operate, the cleanliness of the air condition of the indoor area located remotely from the air purifier 1000 will also improve.

In this embodiment, however, the air that is emitted externally from the air purifier 1000 is air with improved cleanliness. In a case of an air conditioner, the air will have a lowered temperature. In a case of a hot air fan, the air will have a raised temperature. In a case of a humidifier, the air will have increased humidity. Accordingly, a changing indoor air condition may be a condition of, for example, air cleanliness, temperature, and humidity.

Since sensors attached to the air purifier 1000 itself may only detect the air condition of surrounding air, an external sensor 2000 may be disposed in the room at a remote location to sense the air condition of the corresponding area.

The external sensor 2000 may sense the air condition (for example, temperature, humidity, air cleanliness, and fine dust concentration) of the area in which the external sensor 2000 is disposed and transmit the air condition to the air purifier 1000, the artificial intelligent speaker 3000, the user terminal 4000, and the external server 5000.

The artificial intelligent speaker 3000 may perform functions to receive a user command for the air purifier 1000 and transmit the command to the air purifier 1000 or receive information on the operation of the air purifier 1000 to inform the user.

The air purifier 1000 may estimate an indoor air condition based on the information on the air condition sensed by its own sensor and the external sensor 2000 and the operational information of a wind direction, wind speed, and clean mode of the air purifier. The air purifier 1000 may transmit the estimated air condition to the artificial intelligent speaker 3000, the user terminal 4000, or the external server 5000.

The air purifier 1000 may receive information, from the external server 5000, on the operation of other home appliances, information on the electrical power capacity of a home in which the air purifier 1000 is installed, the weather of an area where the home is located, and information on the air condition. Based on this information, the air purifier 1000 may determine an operation or estimate the indoor air condition.

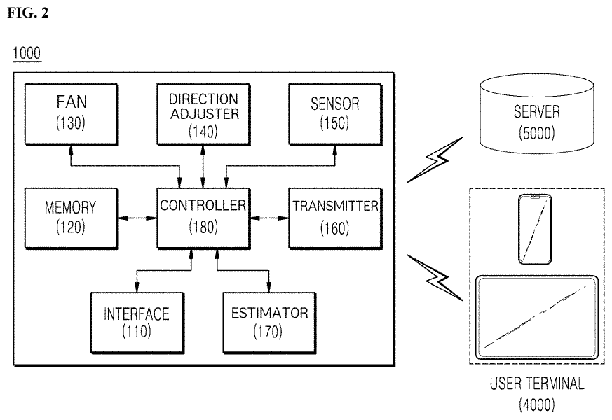

FIG. 2 shows a block diagram of an air conditioner according to an embodiment of the present disclosure.

The air purifier 1000 may include an interface 110 for user interaction, a memory 120 for storing information created at the time of manufacture the air purifier 1000 and for storing information received externally or generated internally, a fan 130 for expelling air, a direction adjuster 140 for adjusting an air discharge direction, a sensor 150 for sensing an external condition, an estimator 170 for estimating an external state, a transmitter 160 for transmitting operational information and estimation information of the air purifier, and a controller 180 for controlling the operation of the air purifier 1000 by interacting with the air purifier 1000. The direction adjuster 140 may comprise an air discharger rotation mechanism.

The interface 110 may be, for example, a display, a button, a touch screen, a speaker, or a microphone. The memory 120 may include volatile and non-volatile memory. The sensor 150 may be composed of sensors capable of sensing at least one of external temperature, humidity, smell, fine dust and ultrafine dust concentration, or air pollution level.

For example, in an automatic mode, the controller 180 of the air purifier 1000 may automatically control the fan 130 and the direction adjuster 140 to perform an air cleaning operation in accordance with the indoor air condition detected by the sensor 150.

That is, the operation of the fan 130 and the direction adjuster 140 is controlled by the controller 180 so that at least one of wind direction or wind speed of the air discharged by the air purifier 1000 may be determined.

The controller 180 may determine at least one of the wind speed automatically generated by the fan 130 or the wind direction determined by the direction adjuster 140 according to the set operation mode and operation target.

In another example, a user may directly input an instruction related to wind direction and wind speed or directly select a specific mode, and the controller 180 may control the operation of the fan 130 and the direction adjuster 140 according to the corresponding instruction.

The estimator 170 may estimate an air condition of a space within a predetermined range from the air purifier 1000 on the basis of information on the wind directions and wind speeds of the air discharged from the air purifier 1000 which are determined according to the operations of the fan 130 and the direction adjuster 140, information related to the air discharging operation of the air purifier 1000 such as an operation mode selected by the user, and information on the air condition sensed by the sensor 150.

The estimator 170 may divide at least a part of the indoor space into a plurality of spaces and estimate an air condition of each of the plurality of spaces. In some implementations, the controller 180 and the estimator 170 may correspond to one or more processors. In other implementations, the controller 180 and the estimator 170 may correspond to software components configured to be executed by one or more processors.

Here, the air condition of the space may denote a space-specific air condition determined with a predetermined unit interval ordered by closest distance from the air purifier 1000. For example, the air condition may denote an air condition of a nearest first space defined by a radius of 1 m around the air purifier 1000, and an air condition of a second space having a radius of 1-2 m around the air purifier 1000.

The air condition may denote the fine dust and ultrafine dust concentration in the space. The air condition in the first space, which is the closest space to the air purifier 1000, may be determined by the fine dust and ultrafine dust concentration sensed by the sensor of the air purifier 1000. At the beginning of the operation of the air purifier 1000, it may be estimated that the fine dust and ultrafine dust concentration in the second space is higher than the fine dust and ultrafine dust concentration in the first space. However, as the operating duration of the air purifier 1000 becomes prolonged, it may be estimated that the fine dust and ultrafine dust concentration in the second space also changes to become closer to the fine dust and ultrafine dust concentration in the first space.

That is, the air condition of the first space and the second space may be estimated differently according to the operating duration of the air purifier 1000.

When the air purifier 1000 begins to operate and the concentration of fine dust detected by the sensor is 10 μg/m³ and the sensor of the air purifier 1000 senses the air condition within a 1 m radius, the estimator 170 may determine that the fine dust concentration is 10 μg/m³ in the area within the 1 m radius around the air purifier 1000 and estimate that the fine dust concentration is 20 μg/m³ in between a radius of 1 m and a radius of 2 m around the air purifier 1000.

As another example, assuming that the air purifier 1000 is capable of purifying an amount of air in between a radius of 1 m and a radius of 2 m for 10 seconds, when 10 seconds passes after the operation of the air purifier 1000 begins, the concentration of fine dust in the space in between a radius of 1 m and a radius of 2 m may be estimated to be further lowered to 10 μg/m³.

The specific estimated value may be determined by a depth neural network model that is trained based on experimental data previously performed for each model of the air purifier 1000. For example, when the air purifier 1000 is operated in each mode in a certain environment for one model, data on how the fine dust concentration value of the space according to each distance from the air purifier 1000 is changed is used as training data for the depth neural network model. This trained depth neural network model is stored in the memory of the air purifier 1000, and the estimator 170 may estimate the space-specific air condition according to the operation of the air purifier 1000 based on the depth neural network model.

Through the schemes as described above, the estimator 170 of the air purifier 1000 may estimate the air condition of the second space based on a positional relationship between the first space and the second space, information on the air discharging operation of the air purifier 1000, and information on the air condition sensed by the sensor 150.

In another scheme, at least one external sensor 2000 is disposed in a position adjacent to the second space to directly sense the air condition of the second space, for example, the fine dust and ultrafine dust concentration, and the detected fine dust and ultrafine dust concentration information may be delivered to the air purifier 1000.

Although not shown in FIG. 2, the air purifier 1000 may include a receiver for receiving information on the fine dust and ultrafine dust concentration sensed by the external sensor 2000. The receiver of the air purifier 1000 may receive other information from other devices.

In this case, the estimator 170 of the air purifier 1000 may more accurately estimate the air condition of the space where the external sensor 2000 is installed and the space adjacent to the corresponding space by additionally considering information on the air condition sensed by the sensor 150, information on the air discharging operation of the air purifier 1000, and air condition information received from the external sensor 2000.

In relation to the wind direction and wind speed generated by the operation of the air purifier 1000, during the manufacturing process of the air purifier 1000, when the air purifier 1000 is operated in an indoor space filled with smog, it is possible to make a visualization of the information on the wind direction and the wind speed of the air discharged from the air purifier 1000 by capturing the movement of the smog with the camera. In such a way, through the accumulated database of created visualizations of information for different operating modes and different wind speeds and wind directions of the air purifier 1000, a learned wind direction and wind speed visualization depth neural network model may be generated. The wind direction and wind speed visualization depth neural network model may be stored in the memory of the air purifier 1000, and may generate information visualizing the wind direction and wind speed to show the user according to the operation of the air purifier 1000.

In the above manner, the air purifier 1000 may be controlled to detect the air condition through the sensor 150, collect information on the operation of the air purifier 1000, estimate the air condition of the space within a certain range from the air purifier 1000 based on the information on the operation of the air purifier 1000 and the information on the air condition sensed through the sensor 150, and transmit information on the estimated air condition of the space to the user terminal 4000.

The above-described embodiments may also be used to control the air condition through other types of air conditioners such as radiators, humidifiers, dehumidifiers, and blowers.

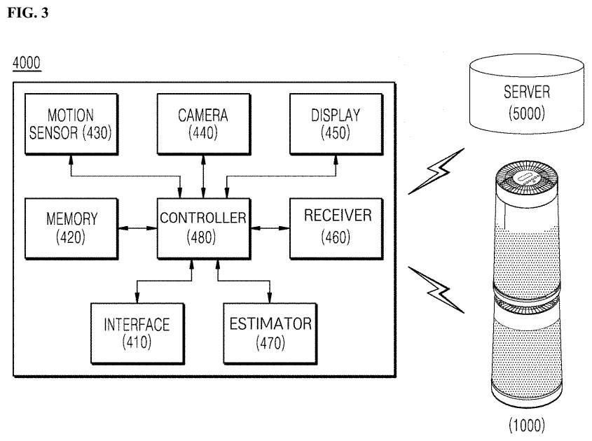

FIG. 3 shows a block diagram of a user terminal according to an embodiment of the present disclosure.

The user terminal 4000 shown in FIG. 3 may be a device used by a user such as a smartphone, a computer, a tablet, and augmented reality eyeglasses to transmit and receive information. The user terminal 4000 may include an interface 410 for user interaction, a memory 420 for storing information created at the time of manufacture of the user terminal 4000, information received externally and information generated internally, a motion sensor 430 for detecting movement of the user terminal 4000, a camera 440 for capturing an indoor space viewed by the user terminal 4000, a display 450 for displaying an image generated by the user terminal 4000, an estimator 470 for estimating the air condition, a receiver 460 for receiving external information, and a controller 480 that interacts with the user terminal 4000 to control the user terminal 4000.

The interface 410 may be, for example, a button, a touch screen, a speaker, or a microphone. The memory 420 may include volatile and non-volatile memory. The motion sensor 430 may be for detecting movement of the user terminal 4000 and may be a combination of, for example, a gyro sensor, an acceleration sensor, or a gravity sensor.

A receiver 460 may receive, from the air purifier 1000, information on the operation of the air purifier 1000, for example, air purifier speed, airflow intensity, air flow direction, and operating mode, and information on the air condition sensed by the sensor of the air purifier 1000. Here, the air condition may include at least one of temperature, humidity, or air pollution level.

The estimator 470 may estimate the space-specific air condition of the indoor space based on the received information on the operation of the air purifier 1000 and the information on the air condition sensed by the sensor 150 of the air purifier 1000.

For example, the estimator 470 of the user terminal 4000 may partition at least a portion of the indoor space into a plurality of spaces, and the space-specific air condition may be configured to include a first air condition of a first space and a second air condition of a second space.

The camera 440 may capture the indoor space, and the controller 480 may generate an image in which information on the air condition of the indoor space estimated by the estimator 470 is synthesized with the indoor space image captured by the camera 440 in order to display augmented reality. The estimator 470 may display the synthesized image on the display. The controller 480 may be referred to as an augmented reality generator depending on its function. In some implementations, the controller 480 and the augmented reality generator may correspond to one or more processors. In other implementations, the augmented reality generator may correspond to software components configured to be executed by one or more processors.

Additionally, the camera 440 may capture the indoor space and the air purifier 1000 disposed in the indoor space.

The estimator 470 may estimate the position of the air purifier 1000 in the indoor space based on this captured image and estimate the space-specific air condition of the indoor space based on the information on the operation of the air purifier 1000, the information on the air condition sensed by the sensor of the air purifier 1000, and the location of the estimated air purifier 1000. Accordingly, the estimator 470 may estimate the influence of the air discharged from the air purifier 1000 in the indoor space position captured by the camera 440 of the user terminal 4000.

The space-specific air condition may include a first air condition of the first space and a second air condition of the second space, and for example, the first space is a space set at the distance closest to the air purifier 1000, and the first air condition may be determined based on information on the air condition sensed by the sensor of the air purifier 1000.

The position of the second space may be relatively determined in relation to the first space. The second air condition may be determined based on the first air condition, the positional relationship between the first space and the second space, and information on the operation of the air purifier 1000.

The first air condition and the second air condition may be determined in a manner similar to that described for the air purifier 1000.

The receiver 460 of the user terminal 4000 may receive additional air condition information which is the air condition information of the area where the corresponding external sensor sensed from the at least one external sensor 2000 is disposed.

The estimator 470 may estimate the space-specific air condition of the indoor space based on the information on the operation of the air purifier 1000, the information on the air condition sensed by the sensor 150 of the air purifier 1000, and the additional air condition information.

For example, if the receiver 460 of the user terminal 4000 receives information from the air purifier 1000 indicating that the fine dust concentration in the vicinity of the air purifier 1000 is 10 μg/m³, the estimator 470 may estimate the fine dust concentration in the first space (for example, a space within a radius of 1 m from the air purifier), which is the closest area to the air purifier 1000, as 10 μg/m³. In addition, the fine dust concentration in the next closest space after the first space, the second space (for example, a space in between a radius of 1 m and a radius of 2 m from the air purifier), may be estimated as 20 μg/m³.

As another example, assuming that the air purifier 1000 is capable of purifying an amount of air in between a radius of 1 m and a radius of 2 m for 10 seconds, when 10 seconds passes after the operation of the air purifier 1000 begins, the estimator 470 of the user terminal 4000 may estimate the concentration of fine dust in the space in between a radius of 1 m and a radius of 2 m to be further lowered to 10 μg/m³.

The specific estimated value may be determined by a depth neural network model that is trained based on experimental data previously performed for each model of the air purifier 1000. For example, when the air purifier 1000 is operated in each mode in a certain environment for one model, data on how the fine dust concentration value of the space according to each distance from the air purifier 1000 is changed is used as training data for the depth neural network model. The trained depth neural network model is stored in the memory of the user terminal 4000, and the estimator 470 may estimate the space-specific air condition according to the operation of the received air purifier 1000 based on the depth neural network model.

Through the schemes as described above, the estimator 470 of the user terminal 4000 may estimate the air condition of the second space based on a positional relationship between the first space and the second space, the received information on the air discharging operation of the air purifier 1000, and information on the air condition sensed by the sensor 150 of the air purifier 1000.

In another scheme, at least one external sensor 2000 located in a space away from the air purifier 1000 may directly sense the air condition of the disposed space, for example, the fine dust and ultrafine dust concentration, and transmit the sensed fine dust and ultrafine dust concentration information to the user terminal 4000.

The receiver 460 of the user terminal 4000 may receive information on the fine dust and ultrafine dust concentration sensed by the external sensor 2000. The receiver 460 of the user terminal 4000 may receive other information from other devices.

In this case, the estimator 470 of the user terminal 4000 may more accurately estimate the air condition of the space where the external sensor 2000 is installed and the space adjacent to the corresponding space by additionally considering information on the air condition sensed and delivered by the sensor 150 of the air purifier 1000, information on the air discharging operation of the air purifier 1000, and air condition information received from the external sensor 2000.

A space set at the distance closest to the external sensor 2000 may be referred to as a third space, and a space set at the distance immediately following may be referred to as a fourth space. For example, the third space may be set to a space within a radius of 1 m from the external sensor 2000, and the fourth space may be set to a space in between a radius of 1 m and a radius of 2 m from the external sensor 2000.

In this manner, a augmented reality eyeglasses 4100 that informs the indoor air condition may be controlled to perform capturing an indoor space through a camera of the augmented reality eyeglasses 4100, receiving information, from the air purifier 1000, on the operation of the air purifier 1000 and information on the air condition sensed by the sensor of the air purifier 1000, estimating the air condition of the indoor space based on the information on the operation of the air purifier 1000 and the information on the air condition sensed by the sensor of the air purifier 1000, and synthesizing information with the estimated indoor space air condition on the indoor space image captured by the camera and displaying the synthesized information on the display.

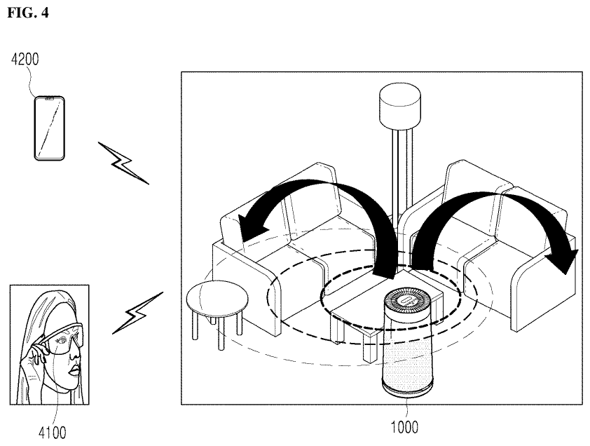

FIG. 4 is a view for explaining information that an air conditioner may provide to a user according to an embodiment of the present disclosure.

As shown in FIG. 4, an image of the indoor space added with information on the flow and cleanliness of the air may be displayed on the user terminal 4000 receiving the information on the operation of the air purifier 1000 and the information of the air condition sensed by the sensor 150 of the air purifier 1000.

For example, looking at the area where the air purifier 1000 is placed with the augmented reality eyeglasses 4100, as shown on the right side of FIG. 4, in addition to the image of the indoor space, movement of wind discharged from the air purifier 1000 is indicated by arrows, and a screen in which air cleanliness is expressed as a contour line may be displayed. A bold line may denote a space with the best air cleanliness, and a line becoming lighter may denote a space with decreasing air cleanliness.

Although not shown in FIG. 4, air cleanliness may be expressed through color. The space with the best air cleanliness, for example, a space with a fine dust concentration of 10 μg/m³ or less, may be indicated in yellow-green, and the space with the next best air cleanliness, for example, a space with a fine dust concentration of 30 μg/m³ or less, may be indicated in green, and the space with the next best air cleanliness after that, for example, a space with a fine dust concentration of less than 50 μg/m³, may be indicated in dark green.

This screen may be displayed on a smartphone 4200 with a camera facing the air purifier 1000, in addition to the augmented reality eyeglasses 4100 facing the air purifier 1000.

In a case where the augmented reality eyeglasses 4100 and the smartphone 4200 are directed at a space without the air purifier 1000, when the space is affected by the wind of the air purifier 1000, the wind and the air cleanliness of the space may be shown on a display.

The augmented reality eyeglasses 4100 may have its own estimator to estimate air condition and air flow discharged from the air purifier 1000, and may receive and display the estimated information from the air purifier 1000.

The camera of the augmented reality eyeglasses 4100 may capture the indoor space and capture the space with the air purifier 1000 to determine the position of the air purifier 1000 in the indoor space. The augmented reality eyeglasses 4100 may transmit, to the air purifier 1000, information on the indoor space and the identified information on the location of the air purifier 1000 in the indoor space.

Based on the position of the air purifier 1000 in the indoor space, information on the operation of the air purifier 1000 received via the receiver, and information on the air condition sensed by the sensor of the air purifier 1000, the estimator of the augmented reality eyeglasses 4100 or air purifier 1000 may estimate the space-specific air condition of the indoor space.

In the case of the air purifier 1000, air cleanliness is mainly displayed on the air purifier 1000, and when the air conditioner is, for example, a humidifier, and a dehumidifier, the air condition information displayed according thereto may vary depending on, for example, air cleanliness, temperature, and humidity.

FIG. 5 is a view for explaining information that an air conditioner may provide to a user according to another embodiment of the present disclosure.

The user terminal 4000 may have map information on the indoor space in which the air purifier 1000 is installed. The user terminal 4000 may receive information on the air condition estimated by the estimator in the user terminal 4000 or estimated by the estimator 170 of the air purifier 1000, and display the information on the map.

The map indicating the air condition may be displayed on the smartphone 4200 that has the map data of the indoor space.

For example, a space A in which the air purifier 1000 is disposed may be indicated as having a lowest air pollution level (yellow-green). Spaces B1 and B2 of a further distance may be indicated as having a low air pollution level (light green). A space C of a distance further away may be indicated as having a medium air pollution level (green). Spaces D1, D2, D3, and D4 of a distance further than that of space C may be indicated as having a high air pollution level (red).

Here, the space partition may be determined by considering a space that may be distinguished from the indoor space due to a wall or pillar in addition to the distance from the air purifier 1000.

The air condition of the indoor space may be determined based on the air condition information sensed by external sensors 2000a, 2000b, and 2000c installed in each space in addition to the operation of the air purifier 1000 and the air condition information sensed by the sensor of the air purifier 1000.

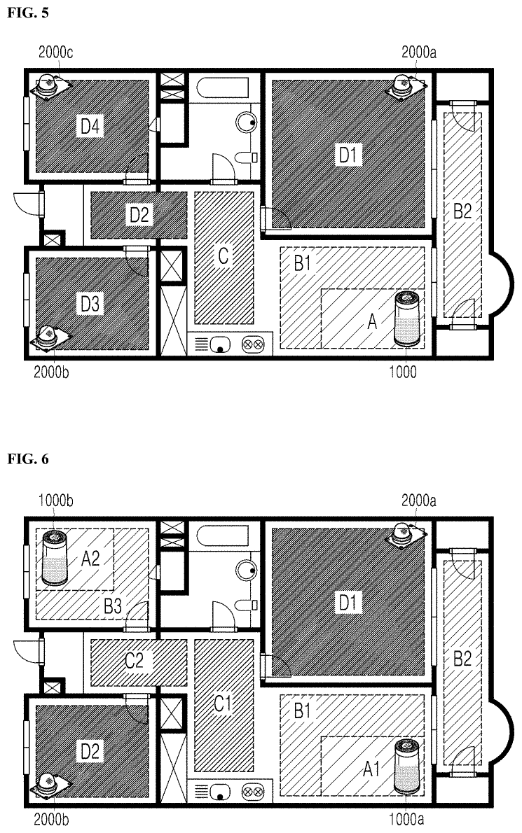

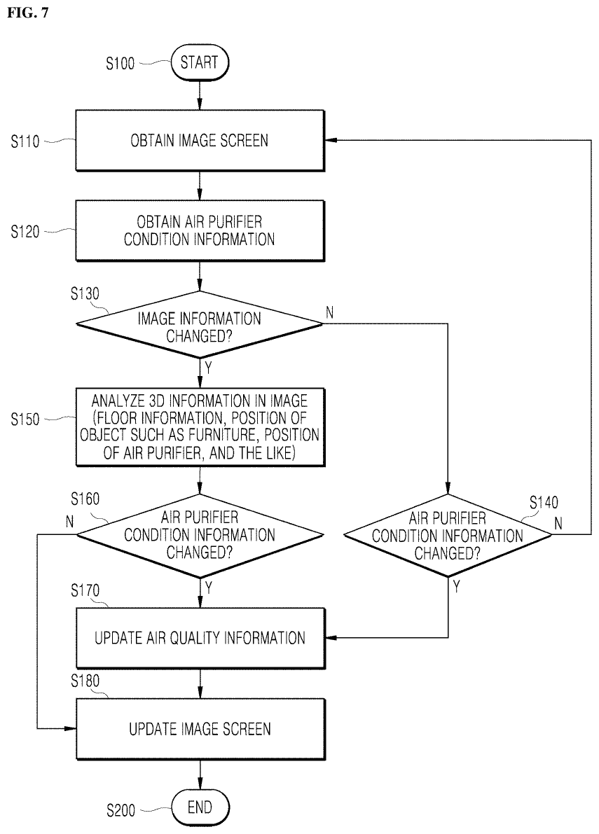

FIG. 6 is a view for explaining information that an air conditioner may provide to a user according to another embodiment of the present disclosure.

In the case of FIG. 6, air purifiers 1000a and 1000b are disposed in two separate spaces. As a result, spaces A1 and A2 closest to each air purifier 1000a and 1000b, respectively, may indicate the lowest pollution level. The spaces B1, B2, and B3 of a further distance may indicate a low pollution level. Spaces C1 and C2 of a distance further away may indicate a medium pollution level. Spaces D1 and D2 of a distance further than that of spaces C1 and C2 may indicate a high pollution level.

In FIG. 6, external sensors 2000a and 2000b are disposed in spaces in which air purifiers 1000a and 1000b are not disposed, and the air condition of the spaces in which the external sensors 2000a and 2000b are disposed may be determined based on the air condition information sensed by each of the external sensors.

FIG. 7 is a flowchart illustrating an operation of a user terminal according to an embodiment of the present disclosure.

In an indoor space, the configuration of the internal space may be changed due to, for example, a rearrangement of furniture, and the information on a status of the air purifier 1000 may be changed such that an updated image of the indoor space may be needed. FIG. 7 shows a method for updating the image screen.

The user terminal 4000 may be augmented reality eyeglasses, which is an augmented reality apparatus.

The augmented reality eyeglasses 4100 may obtain an image of the indoor space with a camera (S110). The receiver 460 of the augmented reality eyeglasses 4100 may receive information on the operation of the air purifier 1000 and information on the air condition sensed by the sensor of the air purifier 1000 (S120).

The augmented reality eyeglasses 4100 may check whether there is a change in information in the captured image (S130) and when there is a change in information, the augmented reality eyeglasses 4100 analyzes 3D information in the image to obtain floor information, location information of objects such as furniture, and the location of the air purifier 1000 (S150).

When there is no change in the image information, whether there is a change in information in the air purifier status is checked (S140). When there is no change in information in the state of the air purifier, the image acquisition continues. When there is a change in information in the state of the air purifier, the air quality, in other words, the air condition, is updated (S170).

When there is a change in the image information and there is a change in information in the state of the air purifier, the air condition and the image screen may be updated based on the changed information (S170).

When there is a change in the image information and there is no change in information in the state of the air purifier, only the image screen may be updated (S180).

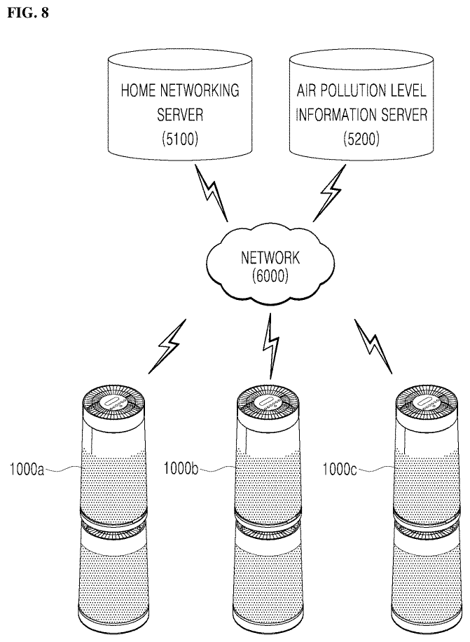

FIG. 8 is a view for explaining a method in which air conditioners operate in conjunction with external servers according to an embodiment of the present disclosure.

Air purifiers 1000a, 1000b, and 1000c may communicate with external servers 5100 and 5200 in a 5^{th} generation mobile networks (5G) communication environment via a network 6000.

The external servers may be a home networking server 5100 and an air pollution level information server 5200. The home networking server 5100 may receive information related to the operation of other air purifiers and information on air conditions sensed by external sensors, and transmit them to the air purifiers 1000a, 1000b, and 1000c.

The air pollution level information server 5200 may provide air purifiers with information on an outdoor air pollution level and weather information, and refer to the information to estimate the outdoor air pollution level and an indoor air temperature affected by weather.

In addition to the air condition sensed by the sensor itself, the air purifiers may further consider the above information received from the home networking server 5100 and the air pollution information server 5200 to estimate an air condition for each indoor space.

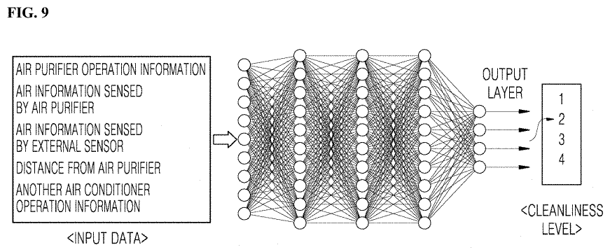

FIG. 9 is a view for explaining a method of an air conditioner and a user terminal determining a cleanliness level according to an embodiment of the present disclosure.

As described above, the air purifier 1000 may estimate the space-specific air condition and determine the cleanliness level for each space based on information related to the operation of the air purifier 1000, air condition information such as wind speed and wind direction sensed by the sensor of the air purifier 1000, air condition information sensed by the external sensor 2000 disposed at a far distance, the distance of the estimated space from the air purifier 1000, and information related to the operation of other air purifiers.

A depth neural network model may be used to make a more sophisticated estimation, and this depth neural network model may be a learning model that is trained using information related to the operation of the air purifier 1000, air condition information in the vicinity of the air purifier 1000, the distance of the estimated space from the air purifier 1000, and a training data set labeled with the air status value of the space in which the data including information related to the operation of the other air conditioners is estimated.

Thus, the depth neural network model for estimating the air condition may be a depth neural network model using pretrained artificial intelligence with information on the changed air condition according to the operation of the air conditioner, which is obtained for each space divided according to the distance from the air conditioner.

The embodiment of the present disclosure may provide an air conditioner and an augmented reality apparatus that allows a user to intuitively check the effect of the air conditioner on the actual air condition of the space in which the user resides.

In addition, the embodiment of the present disclosure may provide information on whether the air conditioner operated by the user achieves a set operation target in an indoor air environment after the user sets the operation target for the air conditioner.

In addition, the embodiment of the present disclosure allows the user to check the air condition of the area located at a distance from the air conditioner in addition to the air condition of the surrounding area where the air conditioner is disposed.

In addition, the embodiment of the present disclosure allows the user to obtain an intuitive understanding of the actual atmospheric environment in addition to reading information on the air condition sensed by sensors and displayed on the air conditioner.

The effects of the present disclosure are not limited to the effects mentioned above, and other effects not mentioned may be clearly understood by those skilled in the art from the following description.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed

More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may be used to take an approach that builds models for deriving predictions and decisions from inputted data.

The term “machine learning” may be used interchangeably with the term “mechanical learning.”

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms “artificial neural network” and “neural network” may be used interchangeably herein.

An ANN may include a number of layers, each including a number of neurons. Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a previous layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron may be activated and output an output value obtained through an activation function.

A deep neural network with a plurality of hidden layers between the input layer and the output layer may be the most representative type of artificial neural network which enables deep learning, which is one machine learning technique.

On the other hand, the term “deep learning” may be used interchangeably with the term “in-depth learning.”

An ANN may be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data may classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network may be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

In this specification, the term ‘grouping’ may be used interchangeably with the term ‘clustering’.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent may determine what action to choose at each time instance, the agent may find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

Also, the hyperparameters are set before learning, and model parameters may be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. In SGD, momentum and NAG are techniques that increase the optimization accuracy by adjusting the step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters may be set to optimal values that provide a stable learning rate and accuracy.

Using the depth neural network model learned by the above methods, the air condition in the spaces divided by the distance from the air purifier 1000 and the divided space may be more accurately estimated.

The example embodiments described above may be implemented through computer programs executable through various components on a computer, and such computer programs may be recorded in computer-readable media. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

The computer programs may be those specially designed and constructed for the purposes of the present disclosure or they may be of the kind well known and available to those skilled in the computer software arts. Examples of program code include both machine code, such as produced by a compiler, and higher level code that may be executed by the computer using an interpreter.

As used in the present application (especially in the appended claims), the terms “a/an” and “the” include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A device, comprising:
a sensor configured to sense an initial air condition;
one or more processors configured to: control an operation of the device and determine an estimated air condition of a space within a predetermined range from the device based on operation information of the device and the initial air condition of the space; and
a transmitter configured to transmit the estimated air condition of the space.

2. The device of claim 1, wherein the operation information includes at least one of a wind direction or a wind speed of air discharged by the device.

3. The device of claim 1, wherein the one or more processors are further configured to: divide at least a part of the space into a first space having a first distance that is smaller than a second distance and a second space having the second distance, wherein the first distance is defined from a middle of the first space to the device and the second distance is defined from a middle of the second space to the device; and determine a first estimated air condition of the first space and a second estimated air condition of the second space.

4. The device of claim 3, wherein the first estimated air condition of the first space is determined based on the initial air condition of the space sensed by the sensor and the operation information of the device, and
wherein the second estimated air condition of the second space is determined based on at least the first estimated air condition, a positional relationship between the first space and the second space or the operation information of the device.

5. The device of claim 1, further comprising a receiver configured to receive additional air condition information sensed by at least one external sensor separated from the device, wherein the additional air condition information received via the receiver is used with the operation information of the device and the initial air condition of the space to determine the estimated air condition of the space.

6. A device, comprising:
a receiver configured to receive, from a second device, operation information of the second device and an initial air condition of a space within a predetermined range from the second device, wherein the initial air condition is sensed by a sensor of the second device;
one or more processors configured to:
determine an estimated air condition of the space based on the operation information of the second device and the initial air condition of the space, wherein the space corresponds to a first image captured with a camera associated with the device,
generate information on the estimated air condition of the space corresponding to the first image captured with the camera, and
cause a display to display the generated information to be visually associated with the space, wherein the display is associated with the device.

7. The device of claim 6, wherein the one or more processors are further configured to determine the estimated air condition of the space by using a depth neural network model that is pretrained with information on a changed air condition according to the operation information of the second device, wherein the estimated air condition is obtained for each space correlated with a plurality of spaces divided from the space according to a distance from the second device.

8. The device of claim 6, wherein the one or more processors are further configured to:
determine an estimated position of the second device in the space based on a second image captured by the camera, wherein the second image includes the second device disposed in the space, and
determine an estimated space-specific air condition of the space based at least on: the operation information of the second device, the initial air condition sensed by the sensor of the second device, or the estimated position of the second device, wherein the estimated space-specific air condition includes a first estimated air condition of a first space having a first distance smaller than a second distance and a second estimated air condition of a second space having the second distance, wherein the first distance is defined from a middle of the first space to the second device and the second distance is defined from a middle of the second space to the second device.

9. The device of claim 8, wherein the first estimated air condition of the first space is determined based on the initial air condition sensed by the sensor of the second device, and
wherein the second estimated air condition is determined based on at least the first estimated air condition, a positional relationship between the first space and the second space, or the operation information of the second device.

10. The device of claim 6, wherein the receiver is further configured to receive additional air condition information sensed by an external sensor separated from the second device,
wherein the additional air condition information received via the receiver is used with the operation information of the second device and the initial air condition of the space to determine the estimated air condition of the space, and
wherein an estimated space-specific air condition comprises a third estimated air condition of a third space having a third distance smaller than a fourth distance and a fourth estimated air condition of a fourth space having the fourth distance, wherein the third distance is defined from a middle of the third space to the external sensor and the fourth distance defined from the middle of the fourth distance to the external sensor.

11. The device of claim 10, wherein the third estimated air condition of the third space is determined based on the additional air condition information sensed by the external sensor, and
wherein the fourth estimated air condition is determined based on the third estimated air condition and a positional relationship between the third space and the fourth space.

12. A method, comprising:
sensing an initial air condition of a space within a predetermined range from a device through a sensor;
collecting operation information of the device;
determining an estimated air condition of the space based on the operation information of the device and the initial air condition of the space; and
transmitting the estimated air condition of the space.

13. The method of claim 12, wherein the estimated air condition of the space further comprises a first estimated air condition of a first space having a first distance that is smaller than a second distance and a second estimated air condition of a second space having the second distance, wherein the first distance is defined from a middle of the first space to the device and the second distance is defined from a middle of the second space to the device.

14. The method of claim 13, wherein the first estimated air condition of the first space is determined based on the initial air condition of the space sensed by the sensor and the operation information of the device, and
wherein the second estimated air condition is determined based on at least the first estimated air condition, a positional relationship between the first space and the second space or the operation information of the device.

15. The method of claim 12, further comprising receiving additional air condition information sensed by at least one external sensor, wherein the additional air condition information received via a receiver is used with the operation information of the device and the initial air condition of the space to determine the estimated air condition of the space.

16. A method, comprising:
receiving, from a second device, operation information of the second device and an initial air condition of a space within a predetermined range from the second device, wherein the initial air condition is sensed by a sensor of the second device;
determining an estimated air condition of the space based on the operation information of the second device and the initial air condition of the space, wherein the space corresponds to a first image captured with a camera associated with a first device;
generating information on the estimated air condition of the space corresponding to the first image captured with the camera; and
causing a display to display the generated information to be visually associated with the space, wherein the display is associated with the first device.

17. The method of claim 16, wherein determining the estimated air condition the space is based on using a depth neural network model that is pretrained with information on a changed air condition according to the operation information of the second device, wherein the estimated air condition is obtained for each space correlated with a plurality of spaces divided from the space according to a distance from the second device.

18. The method of claim 16, wherein determining the estimated air condition further comprises: determining an estimated position of the second device in the space based on a second image captured by the camera, wherein the second image includes the second device disposed in the space, and determining the estimated air condition of the space based at least on the operation information of the second device, the initial air condition sensed by the sensor of the second device, and the estimated position of the second device.

19. The method of claim 18, wherein determining the estimated air condition further comprises: dividing at least a part of the space into a first space having a first distance that is smaller than a second distance and a second space having the second distance, wherein the first distance is defined from a middle of the first space to the second device and the second distance defined from a middle of the second space to the second device, wherein the estimated air condition includes a first estimated air condition of the first space and a second estimated air condition of the second space, and determining the first estimated air condition of the first space and the second estimated air condition of the second space,
wherein the first estimated air condition of the first space is determined based on the initial air condition sensed by the sensor and the operation of the second device, and
wherein the second estimated air condition is determined based on at least the first estimated air condition, a positional relationship between the first space and the second space, or the operation information of the second device.

20. The method of claim 16, wherein receiving the operation information further comprises receiving additional air condition information sensed by an external sensor separated from the second device,
wherein determining the estimated air condition further comprises determining an estimated space-specific air condition of the space based at least in part on the operation information of the second device, the initial air condition of the space, or the additional air condition information,
wherein the estimated space-specific air condition comprises a third estimated air condition of a third space having a third distance smaller than a fourth distance and a fourth estimated air condition of a fourth space having the fourth distance, wherein the third distance is defined from a middle of the third space to the external sensor and the fourth distance is defined from a middle of the fourth space to the external sensor,
wherein the third estimated air condition of the third space is determined based on the additional air condition information sensed by the external sensor, and
wherein the fourth estimated air condition is determined based on the third estimated air condition and a positional relationship between the third space and the fourth space.
